(19) United States
(12) Patent Application Publication
(10) Pub. No.: US 2026/0193088 A1
(43) Pub. Date: Jul. 9, 2026

(54) METHODS OF MAKING METAL CARBIDES UNDER AMBIENT CONDITIONS

(71) Applicant: Georgia Tech Research Corporation, Atlanta, GA (US)

(72) Inventors: Anthony J. Arduengo, III, Cottondale, AL (US); Gard H. Gudvangen, Atlanta, GA (US)

(21) Appl. No.: 19/442,374

(22) Filed: Jan. 7, 2026

Related U.S. Application Data
(60) Provisional application No. 63/742,925, filed on Jan. 8, 2025.

(51) Int. Cl. C01B 32/935

(52) U.S. Cl. CPC C01B 32/935

(57) ABSTRACT

Provided herein are methods for preparing metal carbides from metals and sources of elemental carbon comprising applying mechanical force to a precursor mixture.

### CROSS-REFERENCE TO RELATED APPLICATIONS

This application claims the benefit of priority to U.S. Provisional Application No. 63/742,925, filed Jan. 8, 2025, the entire contents of which are incorporated by reference herein.

### BACKGROUND

Metal carbides are valuable synthetic tools which have a variety of applications across chemical industry. However, the current industrial processes used to prepare these reactive carbides employ extreme conditions with temperatures far above ambient conditions. Additionally, current processes provide carbon units (primarily C₂) that can be used for further elaboration into diverse platform chemicals. A low temperature, cost-effective preparation with the capability of wider product diversity would facilitate the use of metal carbides more broadly and simplify subsequent synthetic steps to platform chemicals. Accordingly, there exists a need for convenient, low-temperature methods of preparing metal carbides.

### SUMMARY OF THE INVENTION

In certain aspects, provided herein are methods of making a metal carbide comprising:
contacting a metal or a metal hydride with a source of elemental carbon to form a precursor mixture; and
applying a mechanical force to the precursor mixture;
thereby producing the metal carbide;
wherein the metal or metal hydride comprises a group 1 metal, a group 2 metal, or a combination thereof.

In further aspects, provided herein are methods of making a metal carbide comprising:
contacting a metal with a source of elemental carbon to form a precursor mixture; and
applying a mechanical force to the precursor mixture;
thereby producing the metal carbide;
wherein the metal comprises a group 1 metal, a group 2 metal, or a combination thereof.

### DETAILED DESCRIPTION OF THE INVENTION

The present disclosure includes exemplary process conditions (e.g., temperature, ball mill rotational frequencies, rates, etc.) that provide certain advantages in context of the systems and methods disclosed herein. However, any suitable conditions may be used, and the person of ordinary skill in the art will appreciate how to vary the conditions of any particular process described herein to obtain results and tune product distribution as needed for particular applications, as contemplated.

In certain aspects, provided herein are methods of making a metal carbide comprising:
contacting a metal or a metal hydride with a source of elemental carbon to form a precursor mixture; and
applying a mechanical force to the precursor mixture;
thereby producing the metal carbide;
wherein the metal or metal hydride comprises a group 1 metal, a group 2 metal, or a combination thereof.

In further aspects, provided herein are methods of making a metal carbide comprising:

contacting a metal with a source of elemental carbon to form a precursor mixture; and
applying a mechanical force to the precursor mixture;
thereby producing the metal carbide;
wherein the metal comprises a group 1 metal, a group 2 metal, or a combination thereof.

In certain embodiments, contacting the metal with the source of elemental carbon is conducted in the absence of a liquid (e.g., a solvent). In some embodiments, the method does not comprise suspending the metal and the source of elemental carbon in a liquid (e.g., a solvent).

In certain embodiments, applying the mechanical force comprises milling the metal and source of elemental carbon. In further embodiments, applying the mechanical force comprises ball-milling the metal and source of elemental carbon. In yet further embodiments, applying the mechanical force is carried out in a planetary ball mill reactor. In still further embodiments, applying the mechanical force is carried out in a reactor comprising an auger. In certain embodiments, applying the mechanical force is carried out in a reactor comprising a gyroscopic vortex mixer.

In certain embodiments, applying the mechanical force is carried out in a reactor comprising a screw extruder.

In certain embodiments, the metal comprises lithium. In further embodiments, the metal is lithium.

In certain embodiments, the metal comprises a group 2 metal. In further embodiments, the metal comprises beryllium. In yet further embodiments, the metal comprises magnesium. In still further embodiments, the metal comprises calcium. In certain embodiments, the metal comprises strontium. In further embodiments, the metal comprises barium.

In certain embodiments, the metal comprises a group 1 metal and a group 2 metal.

In certain embodiments, the metal is lithium. In further embodiments, the metal is beryllium. In yet further embodiments, the metal is magnesium. In still further embodiments, the metal is calcium. In certain embodiments, the metal is strontium. In further embodiments, the metal is barium.

In certain embodiments, the metal hydride comprises lithium hydride.

In certain embodiments, the source of elemental carbon is selected from biochar, charcoal, graphite, carbon black, coal, diamond, a fullerene, coke, or a combination thereof. In further embodiments, the source of elemental carbon is charcoal. In yet further embodiments, the source of elemental carbon is coconut fiber charcoal. In still further embodiments, the source of elemental carbon is biochar. In further embodiments, the source of elemental carbon is suitably prepared biochar.

In certain embodiments, the mechanical force is applied to the precursor mixture under an inert atmosphere. In further embodiments, the mechanical force is applied to the precursor mixture under an atmosphere that is essentially free of water, oxygen, carbon dioxide, and other known reactive gases. In yet further embodiments, the mechanical force is applied to the precursor mixture under an atmosphere that is essentially free of nitrogen. In still further embodiments, the mechanical force is applied to the precursor mixture under an atmosphere of argon.

In certain embodiments, the method is carried out under an inert atmosphere. In further embodiments, the method is carried out under an atmosphere that is essentially free of water and oxygen. In yet further embodiments, the method is carried out under an atmosphere that is essentially free of nitrogen. In still further embodiments, the method is carried out under an atmosphere of argon.

In certain embodiments, the mechanical force is applied to the precursor mixture for at least about 1 hour. In further embodiments, the mechanical force is applied to the precursor mixture from about 1 hour to about 2 weeks.

In certain embodiments, the mechanical force is applied to the precursor mixture at a temperature from about −78° C. to about 60° C. In certain embodiments, the mechanical force is applied to the precursor mixture at a temperature from about −10° C. to about 200° C. In further embodiments, the mechanical force is applied to the precursor mixture at a temperature from about 20° C. to about 120° C. In yet further embodiments, the mechanical force is applied to the precursor mixture at a temperature from about 20° C. to about 80° C. In still further embodiments the mechanical force is applied to the precursor mixture at a temperature from about 20° C. to about 40° C. In certain embodiments, the mechanical force is applied to the precursor mixture at a temperature of about 20° C. In some embodiments, the mechanical force is applied to the precursor mixture at a temperature of about 25° C. In further embodiments, the mechanical force is applied to the precursor mixture at a temperature of about 30° C. In yet further embodiments, the mechanical force is applied to the precursor mixture at a temperature of about 40° C. In still further embodiments, the mechanical force is applied to the precursor mixture at a temperature of about 50° C. In certain embodiments, the mechanical force is applied to the precursor mixture at a temperature of about 60° C. In further embodiments, the mechanical force is applied to the precursor mixture at a temperature of about 70° C. In yet further embodiments, the mechanical force is applied to the precursor mixture at a temperature of about 80° C.

In certain embodiments the mechanical force is applied to the precursor mixture at about ambient temperature.

In some embodiments, the mechanical force is applied to the precursor mixture without external heating.

In certain embodiments, the only heat applied to the reaction is heat generated by the method (e.g., frictional heat generated by applying the mechanical force to the precursor mixture).

In certain embodiments, the mechanical force is applied to the precursor mixture by rotating a ball mill canister at from about 400 Revolutions Per Minute (rpm) to about 700 rpm. In some embodiments, the mechanical force is applied to the precursor mixture by rotating a ball mill canister at from about 200 rpm to about 800 rpm. In further embodiments, the mechanical force is applied to the precursor mixture by rotating a ball mill canister at from about 300 rpm to about 800 rpm. In yet further embodiments, the mechanical force is applied to the precursor mixture by rotating a ball mill canister at from about 300 rpm to about 600 rpm. In certain embodiments, the mechanical force is applied to the precursor mixture by rotating a ball mill canister at about 600 rpm.

In certain embodiments, the mechanical force is applied to the precursor mixture by rotating a ball mill canister at a variable rate from about 200 rpm to about 800 rpm.

In some embodiments, a rate of rotation of the ball mill canister is changed at least two times, and the direction of rotation (e.g., clockwise or counterclockwise) is changed with every other change to the rate of rotation. In further embodiments, the mechanical force is applied to the precursor mixture by rotating a ball mill canister at about 300 rpm for 23 minutes, pausing rotations for 15 seconds, then rotating at about 600 rpm for 47 minutes, pausing the rotations for another 15 seconds and repeating this sequence of rotations in the reverse direction, and then resuming the original rotation direction, continuing to switch the speed and direction of rotation over the course of the entire milling process.

In certain embodiments, the mechanical force is applied to the precursor mixture by rotating a ball mill canister at about 300 rpm for 23 minutes, pausing rotations for 15 seconds, then rotating at about 600 rpm for 47 minutes, pausing the rotations for another 15 seconds and repeating this sequence of rotations in the reverse direction, and then resuming the original rotation direction, continuing to switch the speed and direction of rotation over the course of an entire milling process lasting about 1 day.

In some embodiments, the mechanical force is applied to the precursor mixture by rotating a ball mill canister at about 300 rpm for 23 minutes, pausing rotations for 15 seconds, then rotating at about 600 rpm for 47 minutes, pausing the rotations for another 15 seconds and repeating this sequence of rotations in the reverse direction, and then resuming the original rotation direction, continuing to switch the speed and direction of rotation over the course of an entire milling process lasting about 2 days.

In certain embodiments, the mechanical force is applied to the precursor mixture by rotating a ball mill canister at about 300 rpm for 23 minutes, pausing rotations for 15 seconds, then rotating at about 600 rpm for 47 minutes, pausing the rotations for another 15 seconds and repeating this sequence of rotations in the reverse direction, and then resuming the original rotation direction, continuing to switch the speed and direction of rotation over the course of an entire milling process lasting about 1 week.

In some embodiments, the mechanical force is applied to the precursor mixture by rotating a ball mill canister at about 300 rpm for 23 minutes, pausing rotations for 15 seconds, then rotating at about 600 rpm for 47 minutes, pausing the rotations for another 15 seconds and repeating this sequence of rotations in the reverse direction, and then resuming the original rotation direction, continuing to switch the speed and direction of rotation over the course of an entire milling process lasting about 2 weeks.

In some embodiments, the metal is Li⁺, and the metal carbide comprises a carbide unit having a formula selected from Li₄C, Li₂C, LiC, Li₂C₂, and Li₄C₃.

In certain embodiments, the metal is a group 2 metal, and the metal carbide comprises a carbide unit having a formula selected from M₂C, MC, MC₂, and M₂C₃, where M represents the group 2 metal. In further embodiments, wherein the metal is magnesium, and wherein the metal carbide comprises a carbide unit having a formula selected from Mg₂C, MgC, Mg₂C₂, MgC₂, and Mg₂C₃. In further embodiments, the metal is magnesium, and wherein the metal carbide comprises a carbide unit having a formula of Mg₂C₃. In yet further embodiments, the metal is calcium, and wherein the metal carbide comprises a carbide unit having a formula of CaC₂.

In certain aspects provided herein is a metal carbide prepared according to a method of the present disclosure.

### DEFINITIONS

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art.

The methods and techniques of the present disclosure are generally performed, unless otherwise indicated, according to conventional methods well known in the art and as described in various general and more specific references that are cited and discussed throughout this specification.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

As used herein, the term “inert atmosphere” refers to an atmosphere that does not comprise a significant amount of one or more species (e.g., water, oxygen, nitrogen, and/or carbon dioxide) known to react with a compound of interest (e.g., the metal carbide) or a starting material (e.g., group 1 or 2 metal) from which a compound of interest is derived. Non-limiting examples of common inert atmospheres relevant to the present disclosure include gaseous mixtures that comprise essentially no water, no dioxygen, no dinitrogen, and gaseous mixtures consisting essentially of argon, or other noble gases, or under vacuum.

As used herein the term “suitably prepared” used in connection with charcoal and biochar refers to charcoal and/or biochar material that has undergone a heating process under vacuum that removes essentially all water, residual wood extractives, and any other contaminants that could interfere with the process of this invention. A preferred example of biochar preparation is provided in Example 3, however any suitable process may be used for preparing water- and contaminant-free charcoal and/or biochar for use in the methods of the present disclosure.

As used herein, the term “source,” e.g., a source of elemental carbon, refers to a composition which either comprises the species to which it refers, or from which the species may be easily obtained by common means known to those of skill in the art. For example, sources of elemental carbon relevant to the present disclosure include, as non-limiting examples, substances comprising elemental carbon (e.g., biochar, charcoal, graphite, carbon black, coal).

As used herein, the term “carbide” refers to a composition comprising a carbon-based anion [e.g., wherein a formal anionic charge is localized primarily on a carbon atom, or a fragment comprising multiple carbon atoms] imparting a formal negative charge on the carbon-containing unit. For example, carbide may refer to a composition comprising a carbontetraide, C⁴⁻; an acetylide, C₂²; an ethentetraide, C₂⁴⁻; an allyltetraide, C₃⁴⁻, or other carbon-based anion.

As used herein, the term “metal carbide” refers to a composition comprising a carbide anion as defined above, and at least one metal-carbon interaction or bond, such as, but not limited to, M₄C, M₂C, MC, M₂C₂, MC₂, M₂C₃, and M₄C₃, where M is a Group 1 metal cation (e.g., Li⁺) or 2 metal cation (e.g., Ca²⁺ or Mg²⁺). A metal carbide of the present disclosure may comprise either a single type of carbide unit (e.g., wherein all the carbide anions in the metal carbide composition are acetylide), or a mixture of structurally distinct carbide units (e.g., wherein the metal carbide composition comprises a mixture of ethentetraide and allyltetraide). The metal carbide may be homogeneous (i.e., comprising all or substantially all of the same carbide unit) or heterogeneous (i.e., comprising multiple different carbide units). The carbide unit may be representative of the empirical formula of the metal carbide, but a metal carbide with the same empirical formula of the carbide unit does not necessarily mean that the metal carbide only contains carbide units of the same structure. One of ordinary skill in the art will appreciate that as the charge on the metal unit varies [e.g. Li(I) vs Ca(II)], metal carbides having identical metal to carbon ratios may comprise different carbon-based anion units. For example, Li₂C₂, and CaC₂ may, in certain embodiments, represent lithium acetylide and calcium acetylide respectively—compositions containing acetylide (C₂²⁻) moieties—whereas the compositions Li₄C₂ and Mg₂C₂ may, in certain embodiments, contain ethentetraide (C₂⁴⁻) moieties.

All of the above, and any other publications, patents and published patent applications referred to in this application are specifically incorporated by reference herein. In case of conflict, the present specification, including its specific definitions, will control.

### EXAMPLES

The invention now being generally described, it will be more readily understood by reference to the following examples which are included merely for purposes of illustration of certain aspects and embodiments of the present invention, and are not intended to limit the invention.

When conducted in a typical planetary ball mill such as the PQ-N series (Across International), a 500 mL grade 304 stainless steel vessel containing just enough ¾ inch diameter tungsten carbide steel balls weighing about 60 grams each to cover the bottom of the reaction vessel in a mono-layer (typically about 12 balls for a 3.5 inch inner diameter reaction vessel) was employed for the process, but other vessel sizes and ball types may also be employed. One of ordinary skill in the art will be able to select appropriate impact balls for use based on, e.g., vessel size and reaction scales (total mass of reactants). For example, stainless steel vessels, or tungsten carbide steel vessels may be used with stainless steel or tungsten carbide steel balls weighing from about 20 to about 65 grams. In the examples below, unless otherwise specified, the ball weights were about 60 grams.

### Example 1: General Procedure for Preparing Metal Carbides

Procedure: In a dry box with an inert nitrogen atmosphere, a stainless steel ball mill canister, that was cleaned with stainless steel wool to remove oxidation, steel balls that were cleaned in the same manner were added. The ball mill canister was filled with untarnished metal of a group 1 element, a group 2 element, or an alloy thereof (1 eq total) and a source of elemental carbon (e.g., charcoal, 2 eq—stoichiometry determined by the targeted metal carbide). Argon was allowed to purge out the container through a small (~⅜ inch) opening for a for a time (e.g., 2-3 minutes) to displace other gases (e.g., dinitrogen) before the canister was sealed shut. The canister was milled in a steel planetary ball mill at, e.g., about 300 rpm to 600 rpm for a time ranging from about 1 hour to about 2 weeks.

A sample of the carbide was added to a tared glass vial in a dry box (glovebox), and the top was sealed closed with a screw cap. The sample was then brought out of the dry box (glovebox). An auger-fed powder addition funnel (solid hopper) was attached to a 100 mL round bottom flask equipped with a thermometer port. The RB was charged with 50 mL of distilled water and a stir-bar. The top of the hopper and the thermometer port were both fitted with septa. The thermometer port septum had a thin poly(tetrafluoroethylene) resin tube inserted through it. Using a needle, the system was purged thoroughly with nitrogen through the hopper septum, with the gas escaping through the poly(tetrafluoroethylene) resin tube of the thermometer port. Once sufficiently purged, the needle and the hopper septum were removed and the carbide was added to the powder funnel using a small plastic funnel. The top septum was quickly reinserted and the system was again purged further with nitrogen. Once sufficiently purged, the poly(tetrafluoroethylene) resin tube was inserted into a 100 mL inverted graduated cylinder filled with water. With the water stirring, the auger was turned, dropping the carbide into the water, and causing immediate gas evolution (measured using the inverted graduated cylinder). After the initial hydrolysis, 5 mL of distilled water was injected through the hopper septum to hydrolyze any remaining carbide. The collected gas was removed from the graduated cylinder using a 50 mL glass syringe and a thin flexible tube. The gas collected in the syringe was then bubbled through a deuterated solvent (for example deuterochloroform, deuterobenzene, or deuteroacetone) in an NMR tube and analyzed by proton and carbon NMR to determine the identity of hydrocarbons formed via the reaction of the carbide ion with the distilled water.

### Example 2: Exemplary Procedure for Mechanochemical Synthesis of Magnesium Carbide From Magnesium Turnings and Activated Charcoal

To a 500 mL steel ball mill canister, that was cleaned with alumina to remove oxidation, 131.605 g of steel balls were added, which were cleaned in the same manner. The ball mill canister was filled with 0.780 g untarnished magnesium turnings (32.09 mmol, 1 mol-eq) and 0.777 g activated carbon (64.70 mmol, 2 mol-eq). Argon was allowed to purge out the container for a short time (2 minutes) before the canister was sealed shut. The canister was milled at 580 rpm for 24 h, in an Across International PQ-N 2 steel ball mill.

To work up the sample, the canister was first brought into the dry box (glovebox). A small amount of the product (~100 mg) was added removed from the ball-milling canister with a spatula and transferred to a vial in the dry box. The vial was closed with a cap. The sample was then brought out of the dry box and the cap was rapidly exchanged for a 24/40 rubber septum. Using a 50 mL glass syringe equipped with a long needle, a small amount of distilled water was injected through the septum. The material reacted extremely quickly and produced a gaseous product. The gas was then bubbled through deuterobenzene in an NMR tube. Proton and carbon NMR spectra were taken to confirm the production of propyne and allene from the reaction of the expected [C₃]⁴⁻ allyltetraide ion with the distilled water.

### Example 3: Exemplary Procedure for Mechanochemical Synthesis of Magnesium Carbide From Magnesium Turnings and Prepared Biochar

### Biochar Preparation

A 1 L 24/40 round bottom flask equipped with a vacuum takeoff adapter was charged with 221.7 g of sawmill char (originating primarily from Southern pine). The char was suitably prepared for the carbide synthesis process by drying under vacuum (less than about 1 mmHg) while heating at about 100° C. until the sample reached a constant mass (about 1 hour). The temperature was then increased as follows: about 150° C. for about 1.5 hours; about 200° C. for about 3.5 hours; about 250° C. for about 1 hour; about 300° C. for about 1 hour; about 350° C. for about 7.5 hours; about 375° C. for about 8.5 hours; and about 400° C. for about 1.5 hours. At this point, the mass of the char was constant. The flask was allowed to cool to room temperature under high vacuum and was then back-filled with argon. The sample lost 139.7 g of water, accounting for 63% of the weight.

### Synthesis of Magnesium Carbide

A “500 mL” (having ~400 mL internal volume) steel ball mill container was charged with 123.5 g steel balls (4 large (0.62″), 8 medium (0.46″)). The ball mill canister was brought into the dry box (glovebox) and was charged with 10.97 g of suitably prepared biochar (vide supra) (0.913 mol, 3 eq) followed by 7.403 g magnesium granules (0.305 mol, 1 eq). The container was sealed shut except for the central plug, through which the container was purged with argon. After being purged with argon for 2 minutes the central plug (covered with poly(tetrafluoroethylene) resin tape) was inserted and tightened. The point at which the lid met the base of the canister was taped up with electrical tape as an extra precaution against water/air intrusion. The canister was milled in an Across International PQ-N2 planetary steel ball mill. The canister was set to run 20 cycles of: 47 minutes forward direction at 580 RPM (15 second pause); 23 minutes forward direction at 300 rpm (15 second pause); 47 minutes reverse direction at 580 rpm (15 second pause); and 23 minutes forward direction at 300 rpm (15 second pause). The milling was stopped 1 minute before the end of the last cycle. The canister was mechanically impacted from its outside to loosen any potentially stuck material. The ball mill vessel was then placed in the ball mill in an inverted (top down) configuration. The ball mill vessel was then set to run 10 more cycles in the same pattern as described above. The milling was stopped 78 minutes before the end of the final cycle. The canister was again mechanically impacted to loosen any potentially stuck material, flipped right-side up, and milling was restarted with an additional 20 cycles added to the program (the previous program was left untouched). The milling was stopped 81 minutes into the 9th cycle out of 20. An unrelated reaction conducted in the opposite ball mill position (for counter-balancing purposes) was removed for milling in a different (gyroscopic) mixed. After about 26 hours both ball milling vessels were repositioned in the original ball mill and ball milling was continued as described above. The ball mill was stopped for the final time 11 minutes into the 19^{th} cycle out of 20. In total the canister was milled for 4 days, 18 hours, and 31 minutes. The canister was brought into a dry box (glovebox) and the powdered carbide was removed using a spatula. A dark grey powder (18.11 g) was isolated.

### Analysis of Carbide Product by Hydrolysis

A sample (135 mg) of the above carbide was added to a tared glass vial in a dry box (glovebox), and the top was sealed closed with a screw cap. The sample was then brought out of the dry box (glovebox). An auger-fed powder addition funnel (solid hopper) was attached to a 100 mL round bottom flask equipped with a thermometer port. The RB was charged with 50 mL of distilled water and a stir-bar. The top of the hopper and the thermometer port were both fitted with septa. The thermometer port septum had a thin poly(tetrafluoroethylene) resin tube inserted through it. Using a needle, the system was purged thoroughly with nitrogen through the hopper septum, with the gas escaping through the poly(tetrafluoroethylene) resin tube of the thermometer port. Once sufficiently purged, the needle and the hopper septum were removed and the carbide was added to the powder funnel using a small plastic funnel. A small amount of material (7 mg) was lost to the funnel. Thus, 128 mg was analyzed by this hydrolytic method. The top septum was quickly reinserted and the system was again purged further with nitrogen. Once sufficiently purged, the poly(tetrafluoroethylene) resin tube was inserted into a 100 mL inverted graduated cylinder filled with water. With the water stirring, the auger was turned, dropping the carbide into the water. This caused 19.0 mL of gas evolution (measured using an inverted graduated cylinder). 2.5 minutes into the hydrolysis, 5.0 mL of distilled water was injected through the hopper septum, which added another 5.0 mL to the cylinder (24 mL total). Gas collection was stopped after 5 minutes and 15 seconds. The gas was removed from the graduated cylinder using a 50 mL glass syringe and a thin flexible tube. The gas collected in the syringe was then bubbled through acetone-d₆ in an NMR tube and analyzed by proton and carbon NMR. The NMR spectra showed propyne, allene, acetylene, ethylene, 1,3-butadiene, and traces of dihydrogen. The identities of the products were confirmed by their chemical shifts and coupling constants.

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

We claim:

1. A method of making a metal carbide comprising:
contacting a metal with a source of elemental carbon to form a precursor mixture; and
applying a mechanical force to the precursor mixture;
thereby producing the metal carbide;
wherein the metal comprises a group 1 metal, a group 2 metal, or a combination thereof.

2. The method of claim 1, wherein contacting the metal with the source of elemental carbon is conducted in the absence of a liquid (e.g., a solvent).

3. The method of claim 1, wherein the method does not comprise suspending the metal and the source of elemental carbon in a liquid (e.g., a solvent).

4. The method of claim 1, wherein applying the mechanical force comprises milling the metal and source of elemental carbon.

5. The method of claim 1, wherein applying the mechanical force comprises ball-milling the metal and source of elemental carbon.

6. The method of claim 1, wherein applying the mechanical force is carried out in a planetary ball mill reactor.

7. The method of claim 1, wherein applying the mechanical force is carried out in a reactor comprising an auger.

8. The method of claim 1, wherein applying the mechanical force is carried out in a reactor comprising a gyroscopic vortex mixer.

9. The method of claim 1, wherein applying the mechanical force is carried out in a reactor comprising a screw extruder.

10. The method of claim 1, wherein the metal comprises lithium.

11. The method of claim 1, wherein the metal is lithium.

12. The method of claim 1, wherein the metal comprises a group 2 metal.

13. The method of claim 1, wherein the metal comprises a group 1 metal and a group 2 metal.

14. The method of claim 1, wherein the source of elemental carbon is selected from biochar, charcoal, graphite, carbon black, coal, diamond, a fullerene, coke, or a combination thereof.

15. The method of claim 1, wherein the mechanical force is applied to the precursor mixture under an inert atmosphere.

16. The method of claim 1, wherein the mechanical force is applied to the precursor mixture under an atmosphere of argon.

17. The method of claim 1, wherein the method is carried out under an inert atmosphere.

18. The method of claim 1, wherein the method is carried out under an atmosphere of argon.

19. The method of claim 1, wherein the mechanical force is applied to the precursor mixture at a temperature from about −10° C. to about 200° C.

20. The method of claim 1, wherein the mechanical force is applied to the precursor mixture without external heating.

21. The method of claim 1, wherein the mechanical force is applied to the precursor mixture by rotating a ball mill canister at from about 200 Revolutions Per Minute (rpm) to about 800 rpm.
